(19) United States
(12) Patent Application Publication
(10) Pub. No.: US 2015/0193707 A1
(43) Pub. Date: Jul. 9, 2015

(54) Systems and Methods for Estimating Opportunity in a Reservoir System

(71) Applicants: Luis Arnolde Garibaldi, Katy, TX (US); Landmark Graphics Corporation, Houston, TX (US)

(72) Inventor: Luis Arnoldo Garibaldi, Katy, TX (US)

(21) Appl. No.: 14/417,597

(22) PCT Filed: Jul. 27, 2012
(86) PCT No.: PCT/US2012/048592

§ 371 Date: Jan. 27, 2015

(51) Int. Cl. G06Q 10/06

(52) U.S. Cl. CPC G06Q 10/0635; G06Q 10/067

(57) ABSTRACT

Systems and methods for estimating the opportunity in a reservoir system over different time horizons relative to the critical values of risk and opportunity and corresponding values of an objective variable.

### CROSS-REFERENCE TO RELATED APPLICATIONS

Not applicable.

### STATEMENT REGARDING FEDERALLY SPONSORED RESEARCH

Not applicable.

### FIELD OF THE INVENTION

The present invention generally relates to systems and methods for estimating the opportunity in a reservoir system. More particularly, the present invention relates to estimating the opportunity in a reservoir system over different time horizons relative to the critical values of risk and opportunity and corresponding values of an objective variable.

### BACKGROUND OF THE INVENTION

Modern geostatistical practices often rely on uncertainty analysis to assess the statistical variance (spread) of measured data and prepare the input models for subsequent risk management workflows. Capturing model uncertainty using probabilistic (stochastic) simulation methods usually involves the generation of many equally probable scenarios and realizations of reservoir system properties that best mimic the reservoir system heterogeneity such as, for example, facies distribution, porosity or permeability. Moreover, conditional simulation techniques are used to constrain reservoir system property models with variables such as, for example, acoustic impedance (AI) from the inversion of seismic data, In this manner, a more accurate representation of the opportunity distribution and a more representative and unbiased statistical sampling may be achieved.

The analysis of risk and uncertainty are therefore, important to assess and estimate potential hydrocarbon opportunity from exploration prospects to development fields. In studies on risk and uncertainty analysis, practical applications for preparing the execution of exploitation plans are limited. In the standard risk analysis, the critical probability values are P10, P50 and P90 for objective variables such as, for example, primary reserves (“Prim. Res.”) and original oil in place (“OQIP”). The choice of the critical probability values P10 and P90 is arbitrary and in general overestimates or underestimates the risk and the opportunity to obtain more than the proven value of the objective variable under consideration, which is also generally referred to as the “opportunity.” Because the choice of the critical probability values is arbitrary, it fails to consider the range of influence of intrinsic parameters such as area, reservoir thickness, formation volume factor, porosity, net-to-gross reservoir thickness and recovery factors on the opportunity.

### SUMMARY OF THE INVENTION

The present invention therefore, meets the above needs and overcomes one or more deficiencies in the prior art by providing systems and methods for estimating the opportunity in a reservoir system over different time horizons relative to the critical values of risk and opportunity and corresponding values of an objective variable.

In one embodiment, the present invention includes a method for estimating opportunity in a reservoir system, which comprises: i) measuring critical risk and critical opportunity of an objective variable for the reservoir system using a computer system; and ii) estimating the opportunity in the reservoir system for the objective variable over different time horizons using the critical risk and the critical opportunity.

In another embodiment, the present invention includes a non-transitory program carrier device tangibly carrying computer executable instructions for estimating opportunity in a reservoir system, the instructions being executable to implement; i) measuring critical risk and critical opportunity of an objective variable for the reservoir system; and ii) estimating the opportunity in the reservoir system for the objective variable over different time horizons using the critical risk and the critical opportunity.

In yet another embodiment, the present invention includes a computer-readable medium having a data structure stored thereon, the data structure comprising a data field, the data field comprising a geographic map with a plurality of reservoir systems displayed therein according to a location of each reservoir system, each displayed reservoir system including a corresponding priority code based on a critical risk of an objective variable for each respective reservoir system and a field ranking strategy that separates the plurality of reservoir systems into 60% with a high priority, 30% with a medium priority and 10% with a low priority.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings in which like elements are referenced with like reference numerals, and in which:

FIG. 1 is a flow diagram illustrating one embodiment of a method for implementing the present invention.

FIG. 2 is a probability chart illustrating step 114 in FIG. 1.

FIG. 3 is a priority chart illustrating step 120 in FIG. 1.

FIG. 4 is a geographic map illustrating step 122 in FIG. 1.

FIG. 5 is a flow diagram illustrating one embodiment of a method for implementing step 112 in FIG. 1.

FIG. 6 is a tornado chart illustrating step 502 in FIG. 5.

FIG. 7 is a correlation chart illustrating a correlation between the objective variable (Prim. Res.) and the intrinsic parameter area (A).

FIG. 8 is the tornado chart in FIG. 6 illustrating each correlation chart for a corresponding intrinsic parameter, which are used to build the tornado chart in FIG. 6.

FIG. 9 is a risk/opportunity chart and the tornado chart in FIG. 6 illustrating step 504 in FIG. 5.

FIG. 10 is a block diagram illustrating one embodiment of a system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present invention may be applied in the oil and gas industry, it is not limited thereto and may also be applied in other industries to achieve similar results.

### Method Description

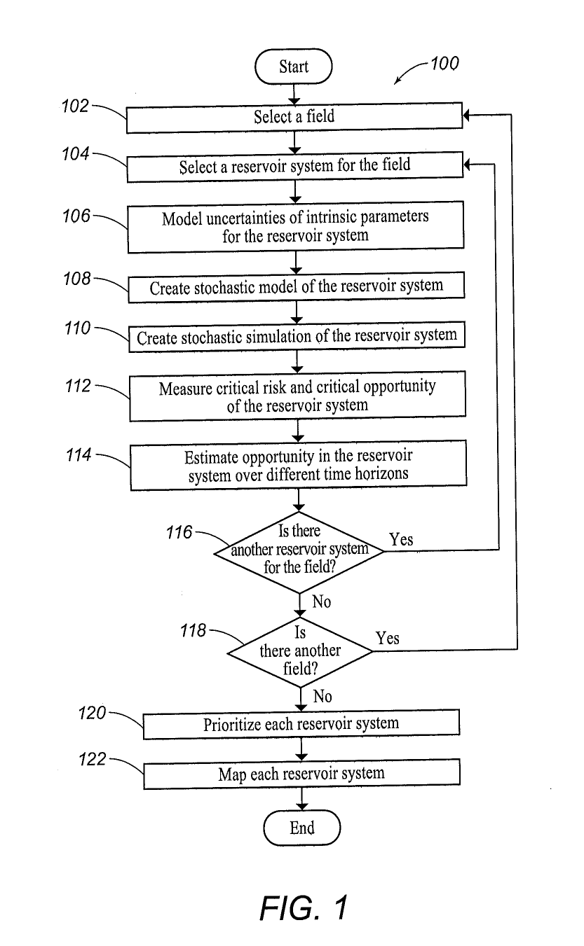

Referring now to FIG. 1, a flow diagram illustrates one embodiment of a method 100 for implementing the present invention.

In step 102, a field is selected from a plurality of fields using techniques well-known in the art.

In step 104, a reservoir system is selected from one or more reservoir systems for the field selected in step 102 using techniques well-known in the art. Each field therefore, may include one or more associated reservoir systems. The reservoir system may be selected at random or using any other predetermined criteria.

In step 106, uncertainties of intrinsic parameters for the reservoir system are modeled using statistical techniques well-known in the art such as, for example, Gaussian modeling or other distributions. Uncertainty represents the variance in expected value for a predetermined objective variable. Intrinsic parameters are parameters used to calculate the objective variable such as, for example, area (A), a constant (α), reservoir thickness (H), porosity (φ), initial water saturation (Swᵢ), initial volumetric volume factor (Boi), and primary recovery factor (Fᵣ). Thus, for primary reserves (Prim. Res.), the intrinsic parameters used to calculate this objective variable may be represented as:

Prim. Res.=αH φ(1−Swᵢ)/Boi (Fᵣ) (1)

The well-known techniques, for example, may use statistics distribution models that are selected based upon data characteristics and the best match between the distribution model and core data to determine the number of statistics models representing the uncertainties of the intrinsic parameters for the reservoir system. Therefore, the number of statistics models will equal the number of intrinsic parameters used to calculate the predetermined objective variable.

In step 108, a stochastic model of the reservoir system is created using techniques well known in the art, the statistics models from step 102, a physical model of the reservoir system that represents the physics for the reservoir system, and the random number generation by sampling rulers.

In step 110, a stochastic simulation of the reservoir system is created using the stochastic model in step 108, artificial samples of the intrinsic parameters and simulation techniques well-known in the art, such as, for example, Monte Carlo simulation. The stochastic simulation produces realizations (probabilistic values) that define the uncertainty of the objective variable. The number of realizations will be dependent on the number required to cover the entire range of the uncertainty for the intrinsic parameters.

In step 112, critical risk and critical opportunity of the objective variable for the reservoir system are measured. Critical risk is the value of the objective variable below which the risk associated with all intrinsic parameters is null or negligible. This is represented by:

$$Crit\_Risk = {Lim}_{ObjVar \to Crit . Val} Risk ( Obj . Var ) = 0 \qquad ( 2 )$$

Similarly, critical opportunity is the value of the objective variable above which the opportunity associated with all intrinsic parameters is null or negligible. This is represented by:

$$Crit\_Opportunity = {Lim}_{ObjVar \to Crit . Val} Opportunity ( Obj . Var ) = 0 \qquad ( 3 )$$

One embodiment of a method for implementing this step is further described in reference to FIG. 5.

In step 114, the probability (opportunity) in the reservoir system over different time horizons (short term, mid-term, long term) is estimated for the objective variable using the results from step 112 and techniques well known in the art. The short term is the incremental value of the objective variable up to the critical risk, which is represented by equation (2). The mid-term is the incremental value of the objective variable up to P₅₀, which is represented by:

Opportunity_Size@midterm=Objective_Variable|P₅₀−Objective_Variable|P_{Crit}_{_{—}}_{Risk} (4)

The long term is the incremental value of the objective variable up to the critical opportunity, which is represented by:

Opportunity_Size@longterm=Objective_Variable|P_{Crit}_{_{—}}_{Opport}−Objective_Variable|P₅₀ (5)

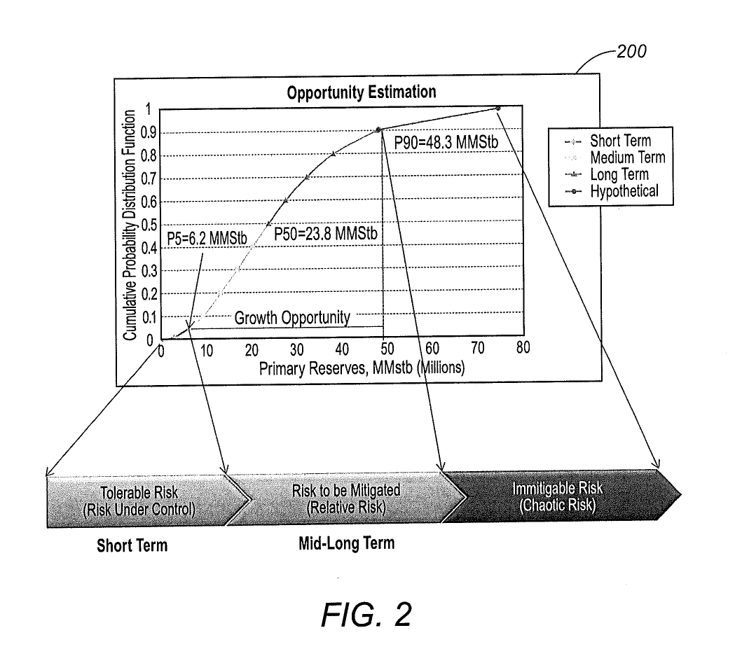

In FIG. 2, for example, the probability chart 200 illustrates the critical risk of the objective variable (Prim. Res.) at P₅ (6.2 MM stb) and the critical opportunity of the objective variable at P₉₀ (48.3 MM stb) for the entire reservoir system. In this manner, the entire range of objective variable probability is managed from P1 to P99 as indicated in Table 1 hereinbelow.

TABLE 1

| Classification | Time Horizon |
|---|---|
| Comfort Zone [P1-P8] | Short term commitment (Starting Point) |
| Probable Expectation (P8-P50] | Probable growth in the mid-term |
| Possible Expectation (P50-P96] | Possible growth in the long term |
| Hypothetical Zone (P96-P99] | Chaotic Risk |

The comfort zone is the range of values for the objective variable that is under current management in the short term time horizon. Probable expectation is the range of values for the objective variable that correspond with an opportunity for growth (probable growth) in the mid-term time horizon. Possible expectation is the range of values for the objective variable that correspond with an opportunity for growth (possible growth) in the long-term time horizon. The hypothetical zone, which is beyond the long term time horizon, is the range of values for the objective variable that is not acceptable for planning purposes.

In step 116, the method 100 determines if there is another reservoir system for the field. If there is another reservoir system for the field, then the method 100 returns to step 104 to select another reservoir system for the same field. If there is not another reservoir system for the field, then method 100 proceeds to step 118. Therefore, there will be a new probability chart illustrating step 114 for each iteration representing another reservoir system.

In step 118, the method determines if there is another field. If there is another field, then the method 100 returns to step 102 to select another field. If there is not another field, then the method 100 proceeds to step 120.

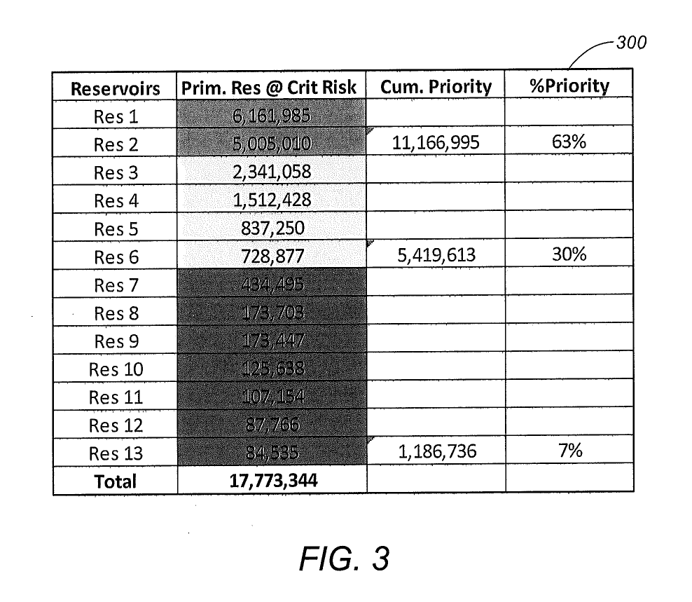

In step 120, each reservoir in each field is prioritized using the critical risk of the objective variable for the reservoir system measured in step 112 and a corresponding priority code. The critical risk for each field is therefore, prioritized from highest to lowest or lowest to highest, which are then grouped and assigned a corresponding priority code to distinguish each group. In FIG. 3, for example, the priority chart 300 illustrates each reservoir for a given field ranked from a highest critical risk to lowest critical risk. Reservoir 1 is the same reservoir used in FIG. 2 to illustrate the critical risk at P₅ (6.2 MM stb) for that reservoir. The priority code is predetermined and may be based on any field ranking strategy. In FIG. 3, for example, fields were prioritized by 60:30:10 and assigned a gray scale priority code based upon the priority percentile in which they fell.

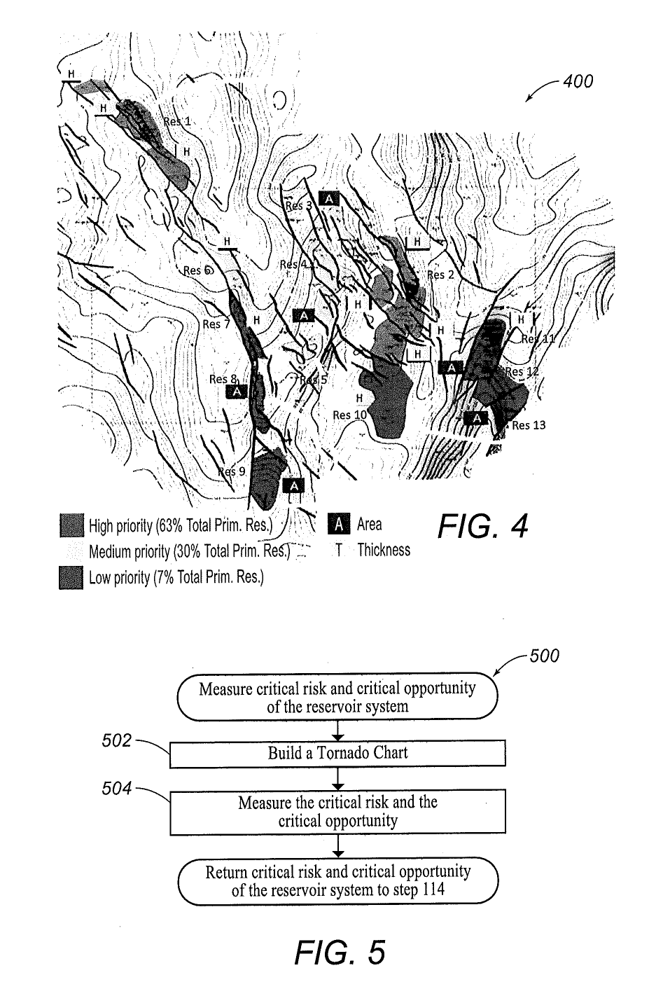

In step 122, each reservoir system is mapped in a geographic map using its corresponding priority code and techniques well-known in the art. In FIG. 4, for example, each reservoir system in FIG. 3 is napped in a geographic map 400 using its corresponding gray scale priority code to illustrate drilling and production priorities and how the intrinsic parameters for area (A) and reservoir thickness (H) that cause a greater impact on the objective variable are distributed for risk mitigation purposes. The reservoir systems with the same gray scale priority code are easily distinguished form the reservoir systems with a different gray scale priority code.

Referring now to FIG. 5, a method 500 for implementing step 112 in FIG. 1 is illustrated.

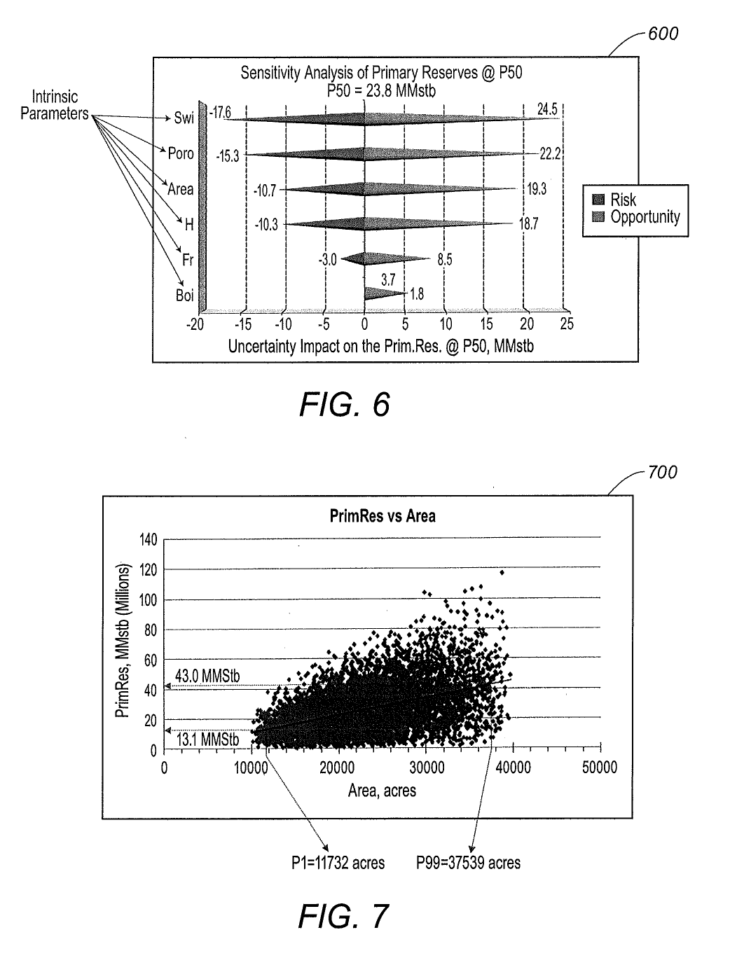

In step 502, a tornado chart is built using techniques well-known in the art, the intrinsic parameters from step 106, and the risk and opportunity measured at P₅₀ from the uncertainty represented by the realizations from step 110. In FIG. 6, for example, the tornado chart 600 illustrates the relative risk and opportunity at P₅₀ for each intrinsic parameter meter of the objective variable (Prim. Res.). In the process of building the tornado chart, each intrinsic parameter from step 106 is correlated with the objective variable to produce a model that represents the correlation. In FIG. 7, for example, a correlation chart 700 illustrates the correlation between the objective variable (Prim. Res.) and the intrinsic parameter area (A). The correlation chart illustrates the maximum confident range of the uncertainty for the intrinsic parameter and the corresponding values of the objective variable using the following equations:

Risk=Correl[Obj.Var.;Intrins.Param.]_{Intrins.Param.@P}_{₁}−Ref|_{Ev[Obj.Var]} (6)

Opportunity=Correl[Obj.Var.;Intrins.Param.]_{Intrinis.Param.@P}_{₉₉}−Ref|_{Ev[Obj.Var]} (7)

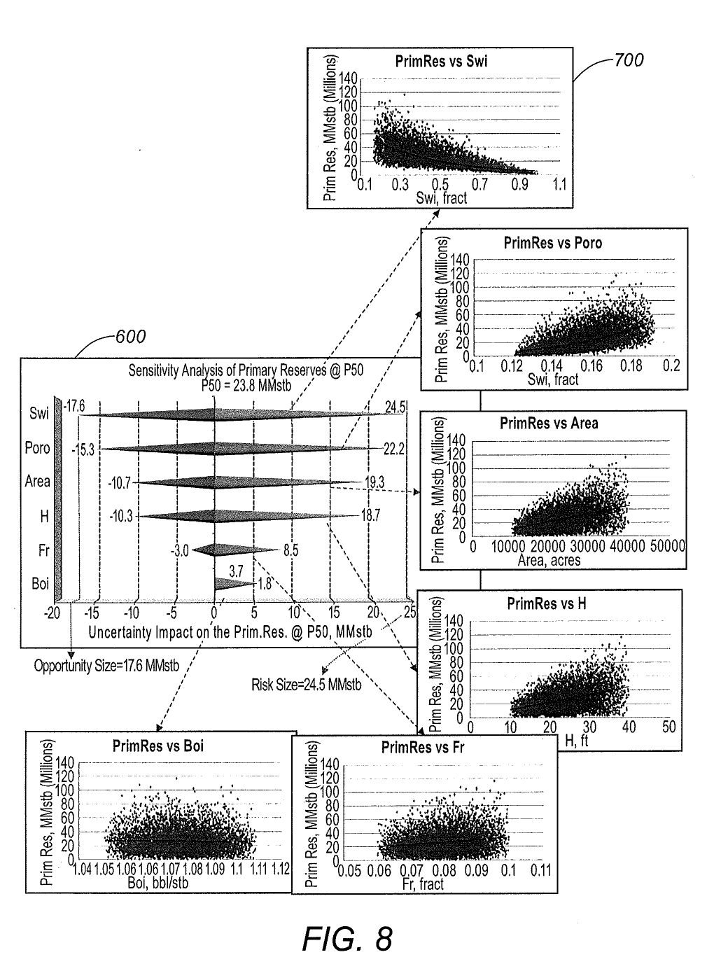

In the correlation chart 700, for example, the maximum confident range of uncertainty for the intrinsic parameter is calculated at P₁ and P₉₉, which results in values of 11,732 acres and 37,539 acres, respectively, for the intrinsic parameter (A) and values of 13.1 MM stb and 43 MM stb, respectively, for the objective variable. P₀ and P₁₀₀ are not taken into account in this process because these values represent absolute existence and absolute nonexistence of the objective variable. A correlation chart is produced in the same manner for each intrinsic parameter. Each correlation chart is then used to model the risk and opportunity at P₅₀ in the tornado chart. In FIG. 8, for example, the tornado chart 600 illustrates the risk (left side) and the opportunity (right side) at P₅₀ for each intrinsic parameter and the impact of each intrinsic parameter on the expected value of the objective variable at P₅₀. The tornado chart 600 in FIG. 8 also illustrates each correlation chart for a corresponding intrinsic parameter, which were used to build the tornado chart 600.

In step 504, the critical risk and the critical opportunity of the reservoir system are determined by using the intrinsic parameter from the tornado chart in step 502 that had the greatest (major) impact on the objective variable and the following equations for critical risk and critical opportunity:

Critical_Risk=Correl[Obj.Var.;Intrins.Param.Major_Impact]|_{Intrins.Param.@P}_{₁} (8)

Critical_Opport=Correl[Obj.Var.; Intrins.Param.Major_Impact]|_{Intrins.Param.@P}_{₉₉} (9)

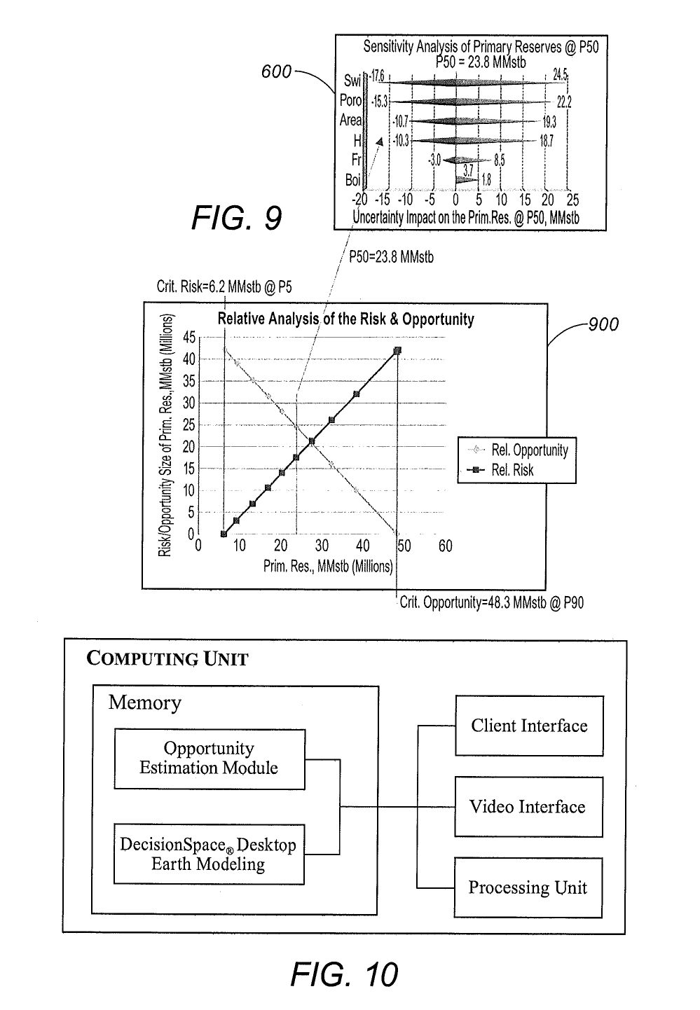

Critical risk is determined by introducing equation (6) into equation (2). Critical opportunity is determined by introducing equation (7) into equation (3). In FIG. 9, for example, the risk/opportunity chart 900 illustrates the value of the objective variable (Prim. Res.) at P₅ (critical risk) and the value of the objective variable at P₉₀ (critical opportunity), which were calculated using equations (8) and (9), respectively, and the intrinsic parameter (Swᵢ) from the tornado chart 600 that had the greatest impact on the objective variable. The value of the critical risk and the critical opportunity of the reservoir system are then returned to step 114.

### System Description

The present invention may be implemented through a computer-executable program of instructions, such as program modules, generally referred to software applications or application programs executed by a computer. The software may include, for example, routines, programs, objects, components, data structures, etc., that perform particular tasks or implement particular abstract data types. DecisionSpace® Desktop Earth Modeling, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

Referring now to FIG. 10, a block diagram illustrates one embodiment of a system for implementing the present invention on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIGS. 1-9. The memory therefore, includes an opportunity estimation module, which enables the methods illustrated and described in reference to FIGS. 1-9 and integrates functionality from the remaining application programs illustrated in FIG. 10. The memory also includes DecisionSpace® Desktop Earth Modeling, which may be used as an interface application to supply input data to the opportunity estimation module and/or display the data results from the opportunity estimation module. Although DecisionSpace® Desktop Earth Modeling may be used as an interface application, other interface applications may be used, instead, or the opportunity estimation module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for estimating opportunity in a reservoir system, which comprises:
measuring critical risk and critical opportunity of an objective variable for the reservoir system using a computer system; and
estimating the opportunity in the reservoir system for the objective variable over different time horizons using the critical risk and the critical opportunity.

2. The method of claim 1, wherein the critical risk is a value of the objective variable below which the risk associated with all intrinsic parameters used to calculate the objective variable is negligible.

3. The method of claim 1, wherein the critical opportunity is a value of the objective variable above which the opportunity associated with all intrinsic parameters used to calculate the objective variable is negligible.

4. The method of claim 1, wherein the objective variable is primary reserves.

5. The method of claim 1, wherein the critical risk and the critical opportunity are measured by:
building a tornado chart using all intrinsic parameters used to calculate the objective variable, a value for risk and a value for opportunity; and
calculating the critical risk and the critical opportunity using one of the intrinsic parameters from the tornado chart that has a greatest impact on the objective variable.

6. The method of claim 5, wherein the value for risk and the value for opportunity are measured at P₅₀ from realizations that define an uncertainty of the objective variable.

7. The method of claim 5, wherein the critical risk is represented by:
Critical_Risk=Correl[Obj.Var.;Intrins.Param.Major_Impact]|_{Intrins.Param.@P}_{₉₉}

8. The method of claim 5, wherein the critical opportunity is represented by:
Critical_Opport=Correl[Obj.Var.;Intrins.Param.Major_Impact]|_{Intrins.Param.@P}₉₉

9. The method of claim 1, wherein the different time horizons are a short-term, a mid-term and a long term, the short-term being an incremental value of the objective variable up to the critical risk, the mid-term being an incremental value of the objective variable up to P₅₀ and the long term being an incremental value of the objective variable up to the critical opportunity.

10. The method of claim 1, further comprising repeating each step in claim 1 for each reservoir system in a field.

11. The method of claim 10, further comprising prioritizing each reservoir system using the critical risk of the objective variable for each respective reservoir system and a corresponding priority code.

12. The method of claim 11, further comprising mapping each reservoir system using the corresponding priority code for each respective reservoir system.

13. A non-transitory program carrier device tangibly carrying computer executable instructions for estimating opportunity in a reservoir system, the instructions being executable to implement:
measuring critical risk and critical opportunity of an objective variable for the reservoir system; and
estimating the opportunity in the reservoir system for the objective variable over different time horizons using the critical risk and the critical opportunity.

14. The program carrier device of claim 13, wherein the critical risk is a value of the objective variable below which the risk associated with all intrinsic parameters used to calculate the objective variable is negligible.

15. The program carrier device of claim 13, wherein the critical opportunity is a value of the objective variable above which the opportunity associated with all intrinsic parameters used to calculate the objective variable is negligible.

16. The program carrier device of claim 13, wherein the objective variable is primary reserves.

17. The program carrier device of claim 13, wherein the critical risk and the critical opportunity are measured by:
building a tornado chart using all intrinsic parameters used to calculate the objective variable, a value for risk and a value for opportunity; and
calculating the critical risk and the critical opportunity using one of the intrinsic parameters from the tornado chart that has a greatest impact on the objective variable.

18. The program carrier device of claim 17, wherein the value for risk and the value for opportunity are measured at P₅₀ from realizations that define an uncertainty of the objective variable.

19. The program carrier device of claim 17, wherein the critical risk is represented by:
Critical_Risk=Correl[Obj.Var.;Intrins.Param.Major_Impact]|_{Intrins.Param.@P}_{₁}

20. The program carrier device of claim 17, wherein the critical opportunity is represented by:
Critical_Opport=Correl[Obj.Var.;Intrins.Param.Major_Impact]|_{Intrins.Param.@P}_{₉₉}

21. The program carrier device of claim 13, wherein the different time horizons are a short-term, a mid-term and a long term, the short-term being an incremental value of the objective variable up to the critical risk, the mid-term being an incremental value of the objective variable up to P₅₀ and the long term being an incremental value of the objective variable up to the critical opportunity.

22. The program carrier device of claim 13, further comprising repeating each step in claim 1 for each reservoir system in a field.

23. The program carrier device of claim 22, further comprising prioritizing each reservoir system using the critical risk of the objective variable for each respective reservoir system and a corresponding priority code.

24. The program carrier device of claim 23, further comprising mapping each reservoir system using the corresponding priority code for each respective reservoir system.

25. A computer-readable medium having a data structure stored thereon, the data structure comprising a data field, the data field comprising a geographic map with a plurality of reservoir systems displayed therein according to a location of each reservoir system, each displayed reservoir system including a corresponding priority code based on a critical risk of an objective variable for each respective reservoir system and a field ranking strategy that separates the plurality of reservoir systems into 60% with a high priority, 30% with a medium priority and 10% with a low priority.
